(19) United States
(12) Patent Application Publication
(10) Pub. No.: US 2010/0181119 A1
(43) Pub. Date: Jul. 22, 2010

(54) PORTABLE MODULAR SCALE SYSTEM

(75) Inventors: Fathi Saigh, Laval (CA); Kennard Wottowa, Chicago, IL (US)

Correspondence Address: THE ECLIPSE GROUP LLP, 10605 BALBOA BLVD., SUITE 300, GRANADA HILLS, CA, 91344, US

(73) Assignee: LOADSENSE TECHNOLOGIES CORPORATION, Chicago, IL (US)

(21) Appl. No.: 12/602,147

(22) PCT Filed: May 28, 2008
(86) PCT No.: PCT/CA2008/001009

§ 371 Date: Nov. 27, 2009

(30) Foreign Application Priority Data
May 28, 2007 (CA) 2,590,174
May 29, 2007 (CA) 2,591,015

(51) Int. Cl. G01G 21/28; G01G 21/00

(52) U.S. Cl. 177/127; 177/126

(57) ABSTRACT

A modular scale in the form of a kit or a system includes a plurality of load sensors, a display unit, and a plurality of electrical communication links for electrically connecting the load sensors to the display unit. The load sensors include connectors, such as jacks, for releasably receiving a complementary plug of a cable. The other end of the cable includes another plug for releasable insertion into a complementary jack of the display unit. One of the load sensors can be a master load sensor for receiving weight data of the other load sensors, referred to as slave load sensors. The master load sensor sums the weight data provided by itself and the slave load sensors, for providing combined weight result data. The scale also includes a rigid case for carrying the various modules of the scale, the case being adapted for use as a weighing platform when opened and supported by the load sensors over a surface.

### FIELD OF THE INVENTION

The invention relates to portable scales.

### BACKGROUND OF THE INVENTION

Portable scales utilized for the purpose of weighing objects are well known in the art, and are available in a myriad of designs, which have been developed for the fulfillment of countless objectives and requirements. For example, the self-contained, portable Chinese “opium scale” has recorded history stretching back to the 17th century as noted in Jacob Leupold's 1726 publication, Theatrum Staticum Universale. However, with all of the advancements in technology there has never been an easily portable, lightweight scale capable of weighing heavy loads (150 kg or more) with a high degree of accuracy (less than 0.5% error). And which can be adopted to almost any type of platform, or, and object regardless of their shapes, and sizes.

Typically, a scale consists of a load cell, or a plurality of load cells, connected to a bottom of a load-receiving platform and to a display unit. The loads cells provide weight data signals corresponding to the weight of an object placed on the platform via electrical connections to the display unit. The display unit receives the weight data signals from the load cells, performs calculations and displays in numeric or alphanumeric text the weight of the object placed on the platform. The functionality of these different components will be discussed in greater detail later.

Existing scale systems on the market today are problematic to repair. For example a load cell is typically damaged by damaging the electrical connection, such as a wire, that connects one of the load sensors to the display unit. This wire can break or become damaged, thereby requiring repair or replacement. Repair or replacement becomes difficult when the damaged portion of the wire is proximate the body of the load cell. This may require disassembly of the load cell, de-soldering the damaged connection at the load cell, and soldering the replacement connection to the load cell. Hence, repairing load cells is a complex task that translates directly into time and resource inefficiencies, which in turn translates into increased cost. If the load cell cannot be disassembled, then replacement of the load cell unit is required. In the worst case, the entire scale may need to be replaced.

Another problem is that existing scales are application specific and are thus fixed to a practical form or shape. For example, a personal floor scale would not be ideal for weighing objects having a larger footprint than the scale surface, since such objects would not rest properly. This poses safety issues and damage to the object if it falls off the scale. Another problem is that higher capacity scales are heavy, and thus not easily transportable.

Therefore, it can be appreciated that there exists a need for new and improved scale system that minimizes repair costs and can be flexibly used for different applications.

### SUMMARY OF THE INVENTION

It is an object of the present invention to obviate or mitigate at least one disadvantage of previous scale systems.

In a first aspect, the present invention provides modular scale system. The modular scale system includes three or more load sensors for being removably positionable under a platform, a display unit and winder cables (cables which can be extended and retracted from a housing). The three or more load sensors each house a load cell and having an extension foot in physical communication with the load cell for relaying a force to the load cell. The load cell provides weight data in response to the force. The display unit is releasably coupled to the at least three load sensors for displaying text corresponding to the weight data provided by each of the three load sensors. The winder cables releasably couple each of the three or more load sensors to the display unit. According to one embodiment of the present aspect, the display unit is directly coupled to each of the three load sensors via the winder cables. In another embodiment, the display unit is directly coupled to a first load sensor of the three load sensors, where the first load sensor receives the weight data from a second load sensor of the three load sensors and a third load sensor of the three load sensors. The first load sensor provides combined weight result data corresponding to a sum of the weight data of the first, second and third load sensors. In the present embodiment, the first load sensor includes a summing board for adding the weight data from the first, second and third load sensors to provide the combined weight result data. In another embodiment, the winder cables are integrated with the body of the load sensor, thereby eliminating the need for separate winder cable components.

In a second aspect, the present invention provides a modular scale system. The modular scale system includes two or more slave load sensors for being removably positionable under a platform, a master load sensor for being removably positionable under a platform, and a display unit. The two slave load sensors each provide first and second weight data in response to an applied force. The master load sensor provides third weight data in response to the applied force. The master load sensor provides combined weight result data corresponding to a sum of the first, second and third weight data. Each of the two or more slave load sensors and the master load sensor houses a load cell and has an extension foot in physical communication with the load cell for relaying the force to the load cell such that the load cell provides corresponding weight data in response to the force. The display unit receives the combined weight result data from the master load sensor, and displays text corresponding to the combined weight result data. According to embodiments of the present aspect, the two or more slave load sensors are releasably coupled to the master load sensor, and the master load sensor is releasably coupled to the display unit by winder cables.

In a third aspect, the present invention provides a modular scale kit for assembling a modular scale. The kit includes at least three load sensors for being removably positionable under a platform, a display unit, and at least one data communication link. The at least three load sensors each house a load cell and have an extension foot in physical communication with the load cell for relaying a force to the load cell, and a sensor connector in data communication with the load cell. The load cell provides weight data to the sensor connector in response to the force. The display unit has at least one display connector for receiving the weight data, and for displaying text corresponding to the weight data. The at least one data communication link is releasably connectable to the sensor connector and the at least one display connector for communicating the weight data from the sensor connector to the at least one display connector. According to an embodiment of the present aspect, the at least one data communication link includes an electric cable. The sensor connector and the at least one display connector are jacks, and the electric cable has a first end and a second end terminated with plugs complementary in shape to the jacks. The jacks can include one of RJ-11 jacks and RJ-45 jacks, and the plugs can include one of an RJ-11 plug and an RJ-11 plug respectively. In an alternate embodiment, the at least one data communication link includes a wireless connection between the sensor connector and the at least one display connector. The sensor connector then includes a first wireless transceiver, and the at least one display connector includes a second wireless transceiver.

In yet another embodiment of the present aspect, the at least one data communication link includes a junction box electrically coupled to the sensor connector, at least one other load sensor, and the display unit. The junction box provides a single output signal corresponding to a sum of the weight data provided by the at least one load sensor and the at least one other load sensor. The junction box includes a first box input connector for releasably receiving a first electrical cable having a complementary plug, the first electrical cable being releasably coupled to the sensor connector. The junction box includes a second box input connector for releasably receiving a second electrical cable having the complementary plug, the second electrical cable being releasably coupled to the at least one other load sensor. The junction box finally includes a box output connector for releasably receiving a third electrical cable having the complementary plug, the third electrical cable being releasably coupled to the at least one display connector.

In a further embodiment of the present aspect, the at least one load sensor includes a master load sensor for receiving additional weight data from a slave load sensor. The master load sensor sums the weight data and the additional weight data to provide combined weight result data to the display unit from the sensor connector. The master load sensor can include another sensor connector identical to the sensor connector, and a summing board electrically connected to the another sensor connector and the load cell for summing the weight data and the additional weight data, for providing the combined weight result data.

According to an embodiment of the present aspect, the modular scale kit further includes a rigid case for carrying load sensors, the display unit, and data communication links for releasably coupling the load sensors to the display unit. The case includes two sidewalls pivotably connected to one another to move between a closed position and an open position, the two sidewalls being substantially coplanar in the open position and supportable over a surface by the load sensors for receiving a load to be weighed. The two sidewalls can include limiting means for maintaining the two sidewalls in the substantially planar position, which can include two abutting stop walls, each abutting stop wall formed on one of the two sidewalls. At least one sidewall includes retaining means for releasably retaining the load sensors, the display unit and the data communication links, and one of the two sidewalls includes a see-through window aligned with the display unit. The display unit further includes an output port for outputting data corresponding to the weight data, such as a USB port. In a further embodiment, the at least one load sensor can include attachment means for releasably attaching the at least one load sensor to an undersurface of a platform for receiving a load to be weighed.

In a fourth aspect, the present invention provides portable scale. The portable scale includes a case having a first side-wall hinged to a second side wall, and load sensors and a display unit releasably retained to the first side-wall and the second side-wall. The first side wall and the second side-wall are movable between a closed position and an open position, where the first side-wall and the second side-wall are substantially co-planar with each other. The load sensors are electrically coupled to the display unit and housed in the case when the first side-wall and the second side-wall are in the closed position. The first side-wall and the second side-wall are supported over a surface by the load sensors in the open position for receiving a load having a weight displayed by the display unit. The first side-wall includes a window for viewing the display unit when the display unit is releasably secured to the first side-wall, and the load sensors are releasably coupled to the display unit. According to an embodiment of the present aspect, each of the load sensors includes at least one sensor connector, and the display unit includes at least one display connector for releasably receiving a cable.

In another embodiment of the present aspect, one of the load sensors is a master load sensor and the remaining load sensors are slave load sensors. The master load sensor sums weight data received from each of the slave load sensors and the master load sensor for providing a combined weight result data corresponding to the weight of the load. The master load sensor includes a number of master sensor connectors corresponding to the number of slave load sensors for receiving the weight data provided by each of the slave load sensors, and an additional sensor connector for providing the combined weight result data. The display unit includes a display connector for receiving the combined weight result data, and each of the slave load sensors includes slave sensor connectors for providing the weight data. The portable scale can include cables having complementary connectors releasably insertable into the master sensor connectors, the slave sensor connectors, the display connector and the additional sensor connector. The cables can include winder cables.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective view of a load sensor according to an embodiment of the invention;

FIG. 2 is a top perspective view of an example load cell including its support;

FIG. 3 is a bottom perspective view of the load cell of FIG. 2;

FIG. 4 is a perspective view of an example display unit, showing a single display connector, according to an embodiment of the invention;

FIG. 5 is a perspective view of a modular scale case in a closed position in accordance to an embodiment of the invention;

FIG. 6 is a side view of the modular scale case of FIG. 5 shown in the open position for receiving a load;

FIG. 7 is a bottom view of the case of FIG. 5 in the open position;

FIG. 8 is a schematic of a junction box, according to an embodiment of the present invention; and,

FIG. 9 is a bottom view of an alternate case in the open position, according to an embodiment of the present invention.

### DETAILED DESCRIPTION

It is to be generally understood that, in the following description and claims, where the invention is described in a device-oriented fashion, the description relates to the device in its operational state—meaning, the device is in an orientation that allows each of the elements associated with the description to perform its implicit function.

Further, in the drawings, it is to be understood that standard components or features that are within the purview of an artisan of ordinary skill, and do not contribute to the understanding of the various embodiments of the invention may be omitted from the drawings to enhance clarity.

Generally, the embodiments of the present invention provides a modular, portable system for weight measurement. A light-weight (under 5 kg for example) yet high-capacity (150 kg and above for example) scale system brings a new level of portability to commercial weighing applications while delivering a high degree of accuracy (less than 0.5% error). The modular approach provides platform independence, allowing nearly any flat-bottomed object (barrel, pallet, plate, board, etc.) to serve as the weighing platform, and minimizes downtime and repair costs by allowing easy component replacement.

The embodiments consist of a display unit and any number of sensors connected thereto via standard cables with plugs (such as phone, USB, LAN or similar mechanisms or telephone winders) and corresponding jacks or receptacles, although many other type of connections, such as electrical, acoustic, radio-frequency, or optical connections are possible. Such range of connections shall be implied in the following discussion of the various modules and their interconnections. To facilitate the utilization of a varying number of sensors, a junction box is used to combine the signals of several sensors into one output source. According to a further embodiment, a master sensor integrates the signals of itself and the other sensors into a single output stream. Such a master sensor facilitates the utilization of any number of load cells through a common display unit and eliminates the need for a separate junction box module. The display unit can execute a variety of features, such as displaying the measured weight in metric or imperial units by toggling a switch, scale zeroing, scale taring, and delayed shut-off for example, by toggling the same switch. Persons skilled in the art will understand that other such features can be easily implemented in the present embodiments.

One embodiment of the present invention provides a modular scale system, which includes a plurality of load sensors for being removably positionable under a platform, a display unit, and a plurality of electrical connectors for electrically connecting the load sensors to the display unit. The electrical connectors have plugs for insertion into complementary-shaped jacks in the display unit and the load sensors. The scale also includes a rigid case for carrying the various modules of the scale, the case being adapted for use as a weighing platform when opened and supported by the load sensors over a surface.

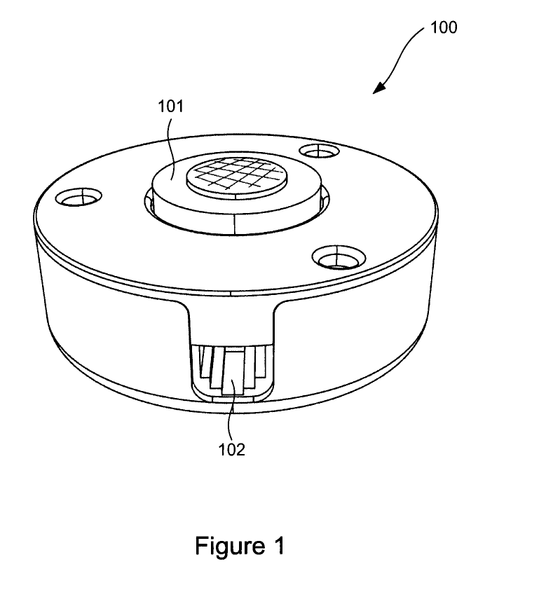

Referring to FIG. 1, there is illustrated in a perspective view, a load sensor, generally indicated by reference numeral 100, in accordance with an embodiment of the present invention. The load sensor 100 houses a load cell (not shown in FIG. 1), and includes an extension foot 101 and an electronic connection 102, also referred to as a sensor connector, both associated with the housed load cell. The sensor connector 102 permits releasable attachment of a cable, and is retained in the body housing the load cell. In operation, a plurality of load sensors 100 can be releasably attached, using optional attachment means, to the undersurface of a platform to be utilized as the weighing platform. Alternatively, the load sensors 100 can simply be positioned and held in place by the weight of the platform.

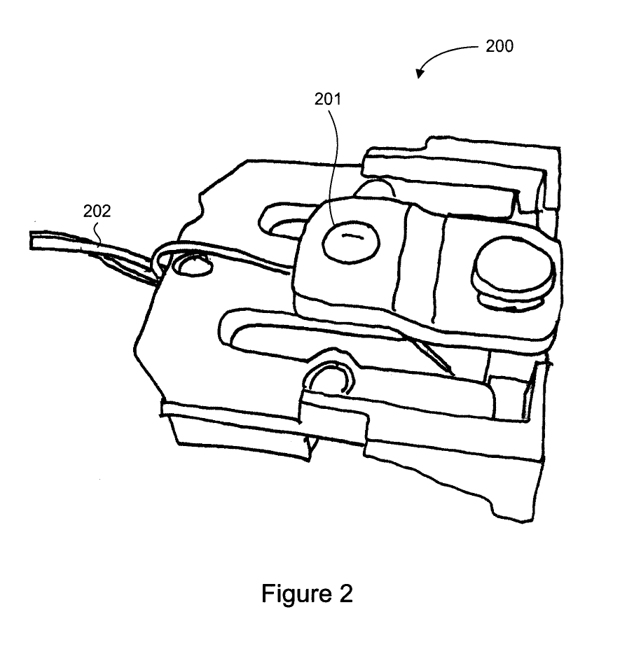

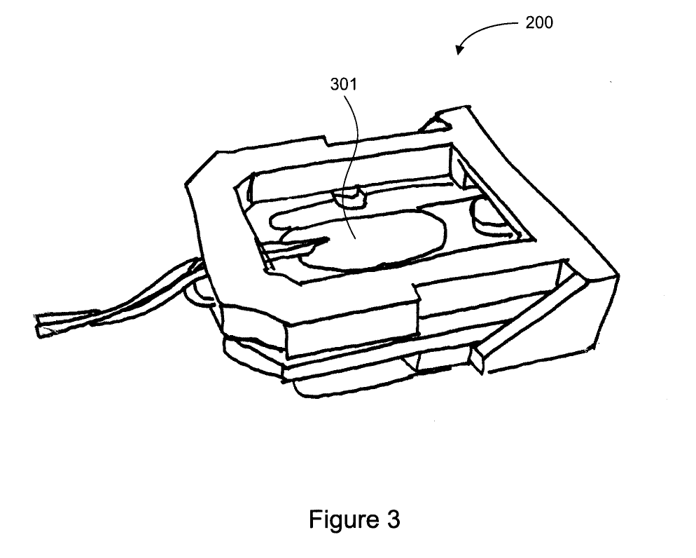

Loads cells come in different shapes and forms. An example load cell is shown in FIGS. 2 and 3, and is generally indicated by reference numeral 200. This load cell can be used in the load sensor 100 shown in FIG. 1. In general, a load cell is an electronic device that is used to convert a force into an electrical signal. Through a mechanical arrangement, which is usually an arm 201, the force being sensed deforms a strain gauge (301 shown adhered to the arm with epoxy). Some load cells are manufactured with support structures for spacing the load cell body from the object it is secured to, and/or for providing clearance when the arm 201 deflects. If the support structure is not provided by the manufacturer, then those skilled in the art will understand that a supplemental support structure should be provided. The strain gauge converts the deformation into an electrical signal. The electrical signal of the load cell 200 is then used to calculate the force applied to the load cell 200 thru the extension foot 101 in FIG. 1.

The extension foot 101 of the load sensor 100 is in mechanical contact with the arm 201 in order to transfer any force applied to the extension foot 101 to the arm 201. The load cell 200 is electrically connected, usually via an electronic cable or wire 202, to the electronic connector 102 of the load sensor 100 for outputting the weight data of the load cell 200. The load sensor 100 of FIG. 1 can include attachment means (not shown) usually on its bottom side for mounting it to the undersurface of a platform.

Returning to the embodiment of FIG. 1, the attachment means of the load sensors 100 can take the form of embedded magnets (for use with metal platforms), suction cups (for use with other smooth-surfaced platforms), double-sided tape, a pin-and-groove locking system, screws and nuts, or any other form of attachment means suitable for attaching the load sensors 100 to the undersurface of the platform in a non-permanent fashion.

The attachment means of the load sensors 100 are usually mounted on the bottom of the load sensors 100 (orientation of FIG. 1). This is normally the case for example with magnets, suction cups and double-sided tape. However, this need not be the case. The attachment means could be associated with the load sensors 100 in any way, provided that it allows the load sensors 100 to be attached to undersurface of the platform in a manner that puts the extender feet 101 in contact with the surface perpendicularly. In other words, when the sensors are supporting the platform over a surface, the extender feet 101 are in contact with the ground and positioned (oriented) such that they can relay force to the arms 201 of the corresponding housed load cells 200.

When used with a weighing platform, at least three load sensors 100 should be used in order to support the platform over a surface—usually the ground or another solid surface. In their inverted position, the load sensors 100 act as foundations for supporting the platform over a surface with their extender feet 101 in contact with the surface.

Placing a load on top of the platform would apply a downward force on the platform, which corresponds to the weight of the load. This downward force is transmitted to the platform's legs—that is, the load sensors 100. Each load sensor 100 is placed at positions underneath the platform in order to minimize tipping of the load. Accordingly, one placement configuration for a rectangular platform is to position each load sensor proximate to its corners. The placement of the load sensors is not limited to any particular configuration, provided the sum of individual forces applied to all of the load sensors 100 equals the weight of the load. For better results, the load sensors 100 are usually uniformly distributed under the platform.

As discussed above, the load cell 200 is electrically connected to the sensor connector 102 of the load sensor 100 for outputting the weight data of the load cell 200. Each load sensor 100 outputs its weight data to a display unit, or to the junction box, or to a master load sensor, as will be discussed later.

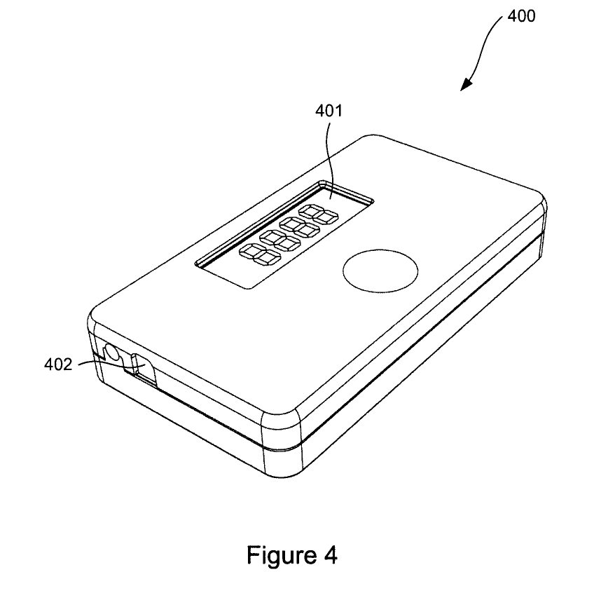

FIG. 4 shows an example of a display unit, generally indicated by reference numeral 400. The display unit 400 typically includes a plurality of electronic connectors 402, also referred to as display connectors for receiving a cable to thereby connect each of the plurality of load sensors 100 to the display unit 400. Only one connector 402 is shown in FIG. 4, but display unit 400 can include any number of display connectors, depending on the number of load sensors it is configured to receive. Alternatively a single connector 402 may receive the combined input of the plurality of load sensors. In these alternative embodiments either a junction box containing a junction board, or one single master load cell that has a built-in junction board to sum the total of all the load cells that are related to one weighing application system in order to provide an aggregate signal via one single cable going to the indicator regardless the number of load cells. The display unit 400 also includes a display 401, which could be an LCD, an LED, or any other type of display suitable for displaying the weight of the load. To calculate the weight of the load, the display unit 400 also includes a central processing unit (CPU), or any other controller. Those skilled in the art will understand that the CPU or controller is calibrated for a selected number of load cells each having a specific rated maximum capacity. The capacity of the load sensors 100 used can vary depending on the application for which the scale is needed. For example, the scale can include four sensors of 50 kg capacity each, to provide a 150 kg total weighing capacity when used with a 50 kg weighing platform, or it can include four sensors of 150 kg capacity each, to provide a 500 kg total weighing capacity when used with a 100 kg weighing platform.

The display unit 400 can be fitted with a Universal Serial Bus (USB) interface/port (not shown) for sending the result to a handheld computing device such, computer or a computer network for integration into an inventory system or a shipping and receiving system, or for sending the result to a printer for the creation of labels and/or postages. Alternatively, wireless technologies such as Blue Tooth or WiFi can be used for communicating the result wirelessly to a handheld computing device, computer or a computer network. Those skilled in the art will understand that circuits required for enabling wireless communication, such as a transceiver for receiving data from the CPU or controller, would be included in the display unit 400. The display unit 400 can be powered in different ways, for example by battery, AC adaptor to provide a DC voltage , by integrated rechargeable batteries, by solar power, or a combination thereof.

The CPU or controller has two main functions: (1) Calibrating the scale and (2) calculating the weight of the load. “Calibrating the scale” includes setting the display 401 to zero regardless of what is currently on the platform. In other words, calibrating the scale means disregarding the initial weight exerted on the load sensors 100 before the load is placed on the platform (also known as the “dead weight”), such as weight exerted on the load sensors 100 by the platform itself. Calibrating the scale could be triggered by having the user tap the display unit 400 or use any other actuation means in electrical communication with the CPU. This actuation means can turn the scale on an off, zero the scale and set the units of measurement. Persons skilled in the art should understand that algorithms can be programmed into the controller or CPU to respond to taps or sustained actuation of the actuation means in order to execute the aforementioned functions. The second main function of the CPU is to add the weight data received from each individual load sensor 100 after a load has been placed on the platform to calculate the weight of the load (“the result”). The weight data received from each individual load sensor 100 thus represents the weight exerted on the load sensor 100 due to the placement of the load on the platform. As will be described later, the CPU or controller of display unit 400 can receive a single combined weight result data representing the aggregate data of all the load sensors in the system sent via a junction box or master load sensor as described above.

The sensor connector 102 and the display connectors 402 can be any form of releasably attachable electrical connectors that would allow the load sensors 100 and the display unit 400 to be electronically connected, thereby allowing the display unit 400 to receive weight data from each load cell 200. Two example connectors are the 6P4C (commonly RJ-11) and 8P8C (commonly RJ-45) jacks, which would allow the load sensors 100 and the display unit 400 to be connected by standard telephone and Local Area Network (LAN) cables terminated at both ends with complementary 6P4C and 8P8C plugs, respectively. The cables can be housed in a protective plastic winder for further protection, ease of storage, portability, and to reach almost any type of platform size, or object shape.

The use of standard jacks such as the RJ-11/RJ-45 jacks in the load sensors 100 and display unit 400 along with corresponding standard telephone/LAN cables, allows for easy and inexpensive replacement of cords that become damaged or worn. USB ports and their associated USB cables are also suggested, to give one more example of commonly used connections. Other cable and jack combinations capable of carrying analog or digital signals are also suitable. Alternatively, wireless communication means can be implemented by using either wireless components that plug into such jacks or wireless components housed in the load sensor instead of jacks. In a wireless communication embodiment, the sensor connectors of the load sensors will include the necessary wireless circuits if the physical jack is omitted. Alternately, a wireless module can be releasably plugged into the jack, where the wireless module includes the necessary wireless circuits for enabling wireless communication. In either wireless embodiment, wireless circuits such as transceivers and power supplies are included in the wireless module or the load sensor itself, and the data communication link becomes the wireless link between the wireless signal enabled load sensor and the wireless signal display unit. Accordingly, the wireless data communication link is releasably connectable between the wireless signal enabled load sensor and the wireless signal display unit, as the signal can be initiated and then terminated when the display unit being turned on/off, for example.

The embodiments of the present invention can be provided as a kit or system for assembling a modular scale. In this embodiment, the modules of the scale—namely, the load sensors 100, display unit 400, and data communication links—can be utilized, as described above, to assemble a modular scale utilizing any rigid platform with a substantially planar undersurface, or suitable undersurface for receiving the load sensors 100.

Following are examples of how the previously described modular scale embodiment can be used. The load sensors 100 can be mounted to the legs of a chair, for example, to create a “sit-down scale” where a user can sit in the chair to weigh himself. Similarly, load sensors 100 can be mounted to the legs of a desk in the shipping and receiving department of a company, or they can be mounted to any other object that can act as a platform for receiving an object to be weighed. In these example applications, the display unit 400 is positioned or placed in a convenient location to allow for the visual inspection of the displayed information. Because the load sensors 100 and the display unit 400 include jacks, well known extension couplings or longer cables can be used if the provided cables are too short.

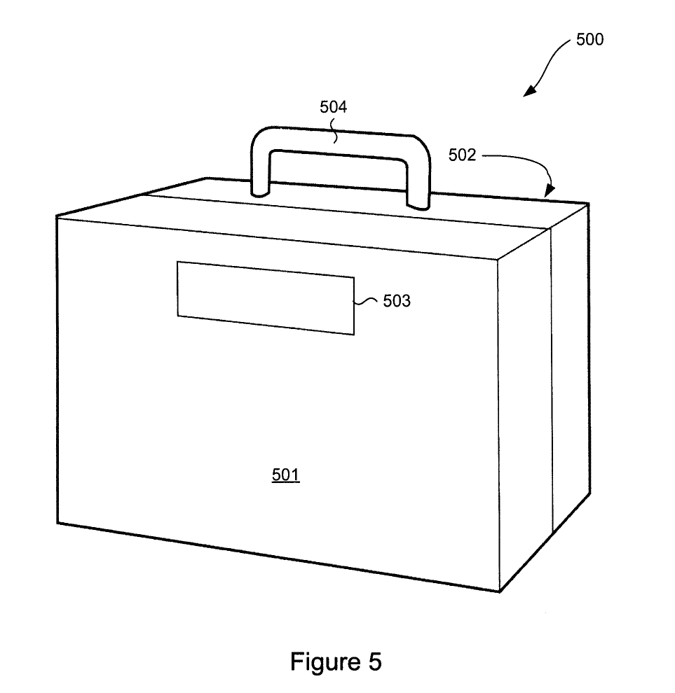

The applications discussed above require the user to acquire a rigid platform for use with the kit. In some situations, such a rigid platform may not be available or inconvenient for a user to transport. In another embodiment of the invention, there is provided a platform along with the load sensors 100, display unit 400, and communication links. The platform comes in the form of a rigid case. FIG. 5 shows an example of such a case in the closed position. The case 500 can be used in the closed position to carry the load sensors 100, display unit 400, communication links, power source/battery charger and winders, for protecting them during travel and to facilitate portability of all the components. The case 500 can be used in the open position, as will be discussed later, to act as a portable platform for the modular scale. The case can be fitted with a see-through window 503 that allows the display unit 400 to be visible while the case 500 is in use as a scale platform. Of course, the display unit 400 is stored with its display screen aligned with and facing the see-through window 503. The case can be fitted with a carrying handle 504 and optional locking features (not shown) to prevent unauthorized use or misuse of the scale. The case 500 can also have supports that allow it to be hung on a wall for easy storage and access (not shown).

In the present embodiment, the aforementioned components within the case are not loosely contained in case 500. This will result in potential damage to the components stored therein. Therefore, the case is fitted with retaining means for the releasable attachment of the scale components to the interior sidewalls of case 500. Such retaining means can be in the form of foam or rubber padding inside the case with cut-outs for frictionally retaining the components. Alternatively, the sensors 100, communication links, winders, and display unit 400 can be held in place via magnets, suction cups, or double-sided tape. Any form of retaining means can be used, provided the components can be removed from the rigid case by the user.

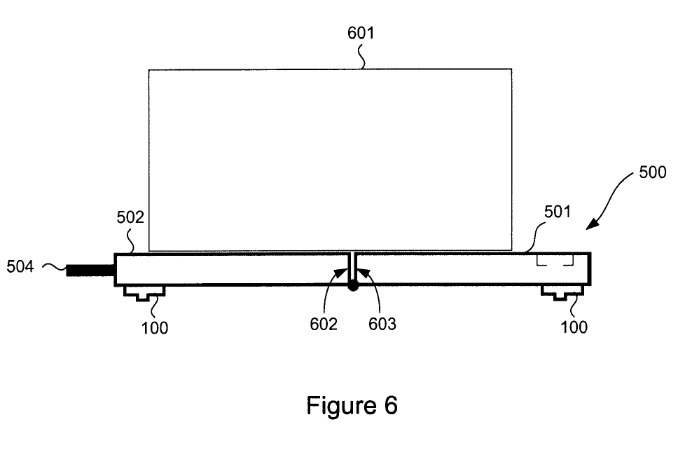

FIG. 6 is a side view of the rigid case of FIG. 5 in an open position. This position is referred to as the weighing position of case 500. The see-through window 503 is facing up so the user can easily view the displayed weight of an object 601 resting on the exterior sidewalls 501,502. As can be seen in FIG. 6, the two bottom walls 602, 603 of the case 500 abut against each other in the open position to prevent the two sidewalls 501,502 from pivoting further. Other limiting means, which should be obvious to the skilled person, could be used to maintain the two sidewalls 501,502 of the case 500 in the position shown, where they are substantially planar for acting as a weighing platform.

Four load sensors 100 (only two can be seen in FIG. 6) are positioned under the open case to support it over the ground or any other solid surface. As previously discussed, the load sensors 100 are releasably retained in case 500, and are positioned such that their extender feet 101 contact the surface when case 500 is oriented in the open position shown in FIG. 6. Furthermore, the seated depth of each load sensor within case 500 is selected to ensure that both sidewalls 501,502 of the case 500 are suspended over the surface when the case is in the open position. Accordingly, case 500 is optionally fitted with molded bases for mounting the load sensors 100 to the interior sidewalls. The molded bases would then serve as the load points for the load sensors 100. Therefore, a user simply opens case 500 to the open position shown in FIG. 6, and rests it on a flat surface to begin weighing operations. When an object 601 is placed on the sidewalls 501, 502 of case 500, its weight is displayed through the window 503 by display unit 400.

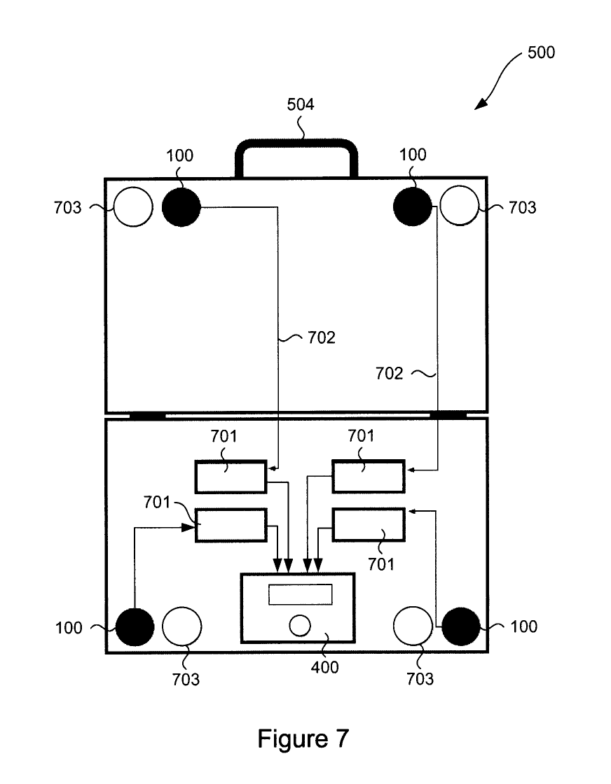

FIG. 7 is a bottom view of the case 500 in the open position, showing one way of mounting the scale components—namely, the load sensors 100, the display unit 400, the winders 701, and their cables 702 (shown in their extended position)—to the case. In the present embodiment, the cables 702 can be terminated with the complementary plug or jack for connection to the display unit 400 and load sensors 100. In an alternative embodiment, the winders can be integrated with the load sensors such that the cable is pulled from the sensor and spring biased to self-retract back into the sensor after use (not shown). In such an embodiment, one terminal of the winder is connected to the load cell and the other terminal of the winder extends from the body of the load sensor 100. The advantage of the integrated load sensor/winder is the reduction in the number of components. The winders 701, cables 702, and the integrated load sensor/winder combination are examples of connection means for electrically connecting the load sensors 100 to the display unit 400. All four load sensors 100 are shown in FIG. 7, and although other positioning is possible, the four load sensors 100 are shown positioned adjacent to the four corners of the open case 500 for supporting the open case 500 over a surface. FIG. 7 also shows four offset cut-outs 703 in the foam or rubber padding placed within the interior of case 500, each cut-out 703 corresponding to a load sensor 100 on the opposite side of the case 500. The load sensors 100 and the cut-outs 703 in one side wall are offset in the horizontal direction for receiving and protecting the load sensors 100 mounted to the other side wall when the case 500 is closed. As would be obvious to the skilled person, the load sensors and cut-outs can be offset in the horizontal direction as shown in FIG. 7, a vertical direction, any diagonal direction, or a combination thereof not shown.

The previously described embodiments of the modular scale have each load sensors 100 connected directly to the display unit 400. Because the display unit 400 is configured for receiving a specific number of load sensors, it will typically include a corresponding number of display connectors 402. However, there may be different applications that require different number of load sensors 100. Therefore, different display units 400 are required, the main difference being the number of display connectors 402 formed therein. Persons skilled in the art will understand that it is not cost-effective to manufacture different display units 400 that are substantially identical to each other, except for the number of display connectors it includes. According to an alternate embodiment, one display unit 400 is provided for all applications.

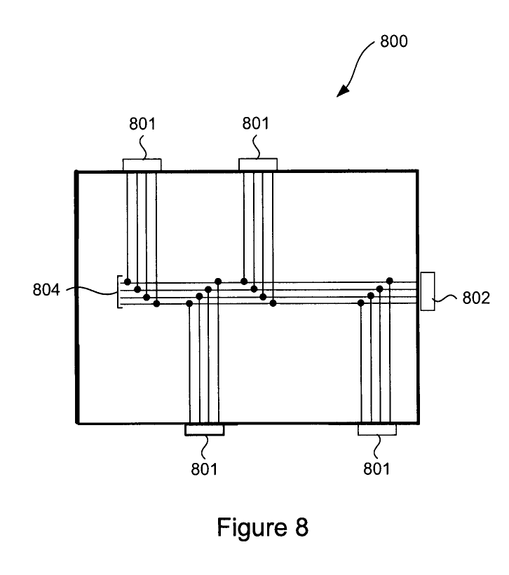

FIG. 8 shows a junction box 800 which can be used with an alternate embodiment of the present invention. In the present embodiment, the load sensors 100 of the modular scale are electronically connected to the display unit 400 via the junction box 800. The junction box 800 has a plurality of electrical connectors 801, also referred to as box input connectors, configured as the previously discussed jacks for example. The junction box 800 can then receive the individual weight data from each load sensor 100 through these connections.

The junction box 800 includes a summing board to integrate or add the weight signal of the load sensors together, for providing a single combined weight result. The junction box 800 also has one additional electrical connector 802 called a box output connector to electrically connect the junction box 800 to the display unit 400 for sending the combined weight result data to the display unit 400. The display unit 400 used for this embodiment includes one display connector for displaying the weight corresponding to the combined weight result data. In the present embodiment, winders 701, their associated cables 702, the previously discussed integrated load sensor/winder combination, and the junction box 800 are the connection means for electrically connecting the load sensors 100 to the display unit 400.

FIG. 8 shows the general wiring internal to the junction box 800. The wiring is typically formed as conductive tracks on a PCB board, also referred to in the present embodiments as a summing board. The box output connector 802 is connected to a signal bus 804 consisting of four wires; +EXT, −EXT, +SIG and −SIG. Excitation +EXT, −EXT are essentially a static voltage provided by the display unit, for powering each of the load sensors connected to the junction box 800. Signals +SIG and −SIG are the signals provided by each load sensor, in millivolts for example, corresponding to a deflection of the strain gauge of each load sensor in response to a load. Each of the electrical connectors 801 has corresponding wires +EXT, −EXT, +SIG and −SIG connected in parallel to the signal bus. Persons of skill in the art should be familiar with the function of the junction box in relation to the load sensors it is connected to.

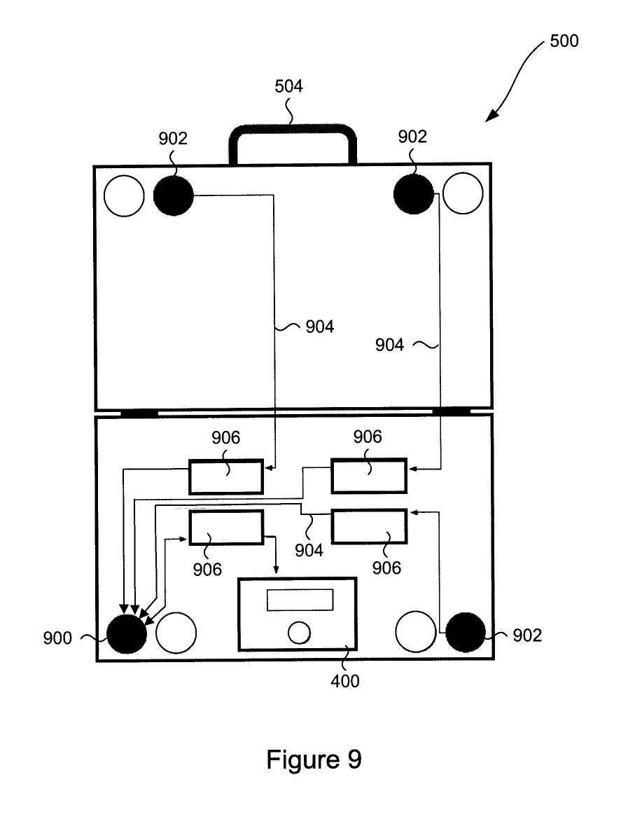

The previously described alternate embodiment of the case 500 including the junction box can be further altered to provide a system with a reduced number of components. In this example embodiment shown in FIG. 9, the summing board of the junction box shown in FIG. 8 is integrated into one of the load sensors. The same numbered components have been previously described for the embodiment shown in FIG. 7. This load sensor is then referred to as the master load sensor 900. The summing board of the master load sensor adds its weight data signal with the weight data signal from all the other load sensors to provide a combined weight result data. Accordingly, the other load sensors are referred to as slave load sensors 902. The master load sensor 900 will include a number of input connectors (ie. jacks) corresponding to the number of slave load sensors 902 of the system, and a single output connector (ie. a jack), for providing the combined weight result data. These jacks, also referred to as sensor connectors, can be the same as those described for the previous embodiments. In this embodiment, the slave load sensors 902 are no different in construction and function than the previously described load sensors, but they are now each connected to the master load sensor 900 via cables 904 having the complementary plugs. A single cable 904 is connected between the single output connector of the master load sensor and the display unit, for providing the display unit 400 with the combined weight result data. Accordingly, the slave load sensors 902 are considered to be coupled to the display unit 400, via the master load sensor 900. In an example modular scale embodiment having four load sensors, the master load sensor 900 has three input jacks and one output jack while the three slave load sensors 902 have one output jack each. All these components can be secured in the previously described case for ease of transportation, which can be used as an instantaneous scale when opened and placed on a surface. In addition to, or alternatively to using cables 904, winders 906 can be used to interconnect the components.

Therefore, as shown in the previously described embodiments, a portable modular scale including separate load sensor and display unit components that can be releasably connected to each other, can be used to convert suitable objects into scales. The use of jacks and plugs to permit releasable connection of the components facilitates replacement of the inexpensive cables, while winder cables allow the load sensors to be used with platforms of many different sizes. A case has been disclosed for carrying the components of the modular scale, which functions as an instant scale when opened and placed on a surface. While the present embodiments illustrate systems having four load sensors, any number of load sensors can be used, provided the display unit, junction box, or master load sensor is configured for receiving the specific number of load sensors being used.

The above description and accompanying drawings are presented to enable any person skilled in the art to make use of the invention and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. The appended claims, properly construed, form the only limitation upon the scope of the invention.

What is claimed is:

1. A modular scale system comprising:
at least three load sensors for being removably positionable under a platform, each of the least three load sensors housing a load cell and having an extension foot in physical communication with the load cell for relaying a force to the load cell, the load cell providing weight data in response to the force;
a display unit releasably coupled to at least one of the at least three load sensors for displaying text corresponding to the weight data provided by each of the at least three load sensors; and,
winder cables for releasably coupling each of the at least three load sensors to the display unit.

2. The modular scale system of claim 1, wherein the display unit is directly coupled to each of the at least three load sensors via the winder cables.

3. The modular scale system of claim 1, wherein the display unit is directly coupled to a first load sensor of the at least three load sensors, the first load sensor receiving the weight data from a second load sensor of the at least three load sensors and a third load sensor of the at least three load sensors, for providing combined weight result data corresponding to a sum of the weight data of the first, second and third load sensors.

4. The modular scale system of claim 3, wherein the first load sensor includes a summing board for adding the weight data from the first, second and third load sensors to provide the combined weight result data.

5. The modular scale system of claim 1, wherein the winder cables are integrated into each of the at least three load sensors.

6. A modular scale system comprising:
at least two slave load sensors for being removably positionable under a platform, each of the at least two slave load sensors providing first and second weight data in response to an applied force;
a master load sensor for being removably positionable under a platform, for providing third weight data in response to the applied force, the master load sensor providing combined weight result data corresponding to a sum of the first, second and third weight data, each of the at least two slave load sensors and the master load sensor housing a load cell and having an extension foot in physical communication with the load cell for relaying the force to the load cell, the load cell providing corresponding weight data in response to the force; and,
a display unit for receiving the combined weight result data from the master load sensor, and for displaying text corresponding to the combined weight result data.

7. The modular scale system of claim 6, wherein the at least two slave load sensors are releasably coupled to the master load sensor, and the master load sensor is releasably coupled to the display unit.

8. The modular scale system of claim 7, wherein winder cables releasably couple each of the at least two slave load sensors to the master load sensor, and the master load sensor to the display unit.

9. A modular scale kit for assembling a modular scale, the kit comprising:
at least three load sensors for being removably positionable under a platform, each housing a load cell and having an extension foot in physical communication with the load cell for relaying a force to the load cell, and a sensor connector in data communication with the load cell, the load cell providing weight data to the sensor connector in response to the force;
a display unit having at least one display connector for receiving the weight data, and for displaying text corresponding to the weight data; and
at least one data communication link releasably connectable to the sensor connector and the at least one display connector for communicating the weight data from the sensor connector to the at least one display connector.

10. The modular scale kit of claim 9, wherein the at least one data communication link includes an electric cable.

11. The modular scale kit of claim 10, wherein the sensor connector and the at least one display connector are jacks, and the electric cable has a first end and a second end terminated with plugs complementary in shape to the jacks.

12. The modular scale kit of claim 11, wherein the include one of RJ-11 jacks and RJ-45 jacks, and the plugs include one of an RJ-11 plug and an RJ-11 plug, respectively.

13. The modular scale kit of claim 9, wherein the at least one data communication link includes a wireless connection between the sensor connector and the at least one display connector.

14. The modular scale kit of claim 13, wherein the sensor connector includes a first wireless transceiver and the at least one display connector includes a second wireless transceiver.

15. The modular scale kit of claim 11, wherein the electric cable includes a winder cable.

16. The modular scale kit of claim 9, wherein the at least one data communication link includes a junction box electrically coupled to the sensor connector, at least one other load sensor, and the display unit, the junction box providing a single output signal corresponding to a sum of the weight data provided by the at least one load sensor and the at least one other load sensor.

17. The modular scale kit of claim 16, wherein the junction box includes
a first box input connector for releasably receiving a first electrical cable having a complementary plug, the first electrical cable being releasably coupled to the sensor connector,
a second box input connector for releasably receiving a second electrical cable having the complementary plug, the second electrical cable being releasably coupled to the at least one other load sensor, and
a box output connector for releasably receiving a third electrical cable having the complementary plug, the third electrical cable being releasably coupled to the at least one display connector.

18. The modular scale kit of claim 9, wherein the at least one load sensor includes a master load sensor for receiving additional weight data from a slave load sensor, the master load sensor summing the weight data and the additional weight data to provide combined weight result data to the display unit from the sensor connector.

19. The modular scale kit of claim 18, wherein the master load sensor includes
another sensor connector identical to the sensor connector, and
a summing board electrically connected to the another sensor connector and the load cell for summing the weight data and the additional weight data, for providing the combined weight result data.

20. The modular scale kit of claim 9 further comprising a rigid case for carrying load sensors,
the display unit, and data communication links for releasably coupling the load sensors to
the display unit, the case including
two sidewalls pivotably connected to one another to move between a closed position and an open position, the two sidewalls being substantially coplanar in the open position and supportable over a surface by the load sensors for receiving a load to be weighed.

21. The modular scale kit of claim 20, wherein the two sidewalls include limiting means for maintaining the two sidewalls in the substantially planar position.

22. The modular scale kit of claim 21, wherein the limiting means include two abutting stop walls, each abutting stop wall formed on one of the two sidewalls.

23. The modular scale kit claim 20, wherein at least one sidewall includes retaining means for releasably retaining the load sensors, the display unit and the data communication links.

24. The modular scale kit claim 23, wherein one of the two sidewalls includes a see-through window aligned with the display unit.

25. The modular scale kit claim 9, wherein the display unit further comprises an output port for outputting data corresponding to the weight data.

26. The modular scale kit of claim 25, wherein the output port is a USB port.

27. The modular scale kit of claim 9, wherein the at least one load sensor includes attachment means for releasably attaching the at least one load sensor to an undersurface of a platform for receiving a load to be weighed.

28. A portable scale comprising:
a case having a first side-wall hinged to a second side wall, the first side wall and the second side-wall being movable between a closed position and an open position where the first side wall and the second side-wall are substantially co-planar with each other; and,
load sensors and a display unit releasably retained to the first side-wall and the second side-wall, the load sensors being electrically coupled to the display unit and housed in the case when the first side-wall and the second side-wall are in the closed position, the first side wall and the second side-wall being supported over a surface by the load sensors in the open position for receiving a load having a weight displayed by the display unit.

29. The portable scale of claim 28, wherein the first side-wall includes a window for viewing the display unit when the display unit is releasably secured to the first side-wall.

30. The portable scale of claim 28, wherein the load sensors are releasably coupled to the display unit.

31. The portable scale of claim 30, wherein each of the load sensors includes at least one sensor connector, and the display unit includes at least one display connector for releasably receiving a cable.

32. The portable scale of claim 30, wherein one of the load sensors is a master load sensor and the remaining load sensors are slave load sensors, the master load sensor summing weight data received from each of the slave load sensors and the master load sensor for providing a combined weight result data corresponding to the weight of the load.

33. The portable scale of claim 32, wherein the master load sensor includes a number of master sensor connectors corresponding to the number of slave load sensors for receiving the weight data provided by each of the slave load sensors and an additional sensor connector for providing the combined weight result data, the display unit includes a display connector for receiving the combined weight result data, and each of the slave load sensors includes slave sensor connectors for providing the weight data.

34. The portable scale of claim 33, further including cables having complementary connectors releasably insertable into the master sensor connectors, the slave sensor connectors, the display connector and the additional sensor connector.

35. The portable scale of claim 34, wherein the cables include winder cables.
